(19) United States
(12) Patent Application Publication
(10) Pub. No.: US 2026/0225285 A1
(43) Pub. Date: Aug. 6, 2026

(54) SYSTEM AND METHOD FOR THE PRODUCTION OF FOOD-GRADE RECYCLED POLYOLEFINS

(71) Applicant: SACMI COOPERATIVA MECCANICI IMOLA SOCIETA' COOPERATIVA, IMOLA (BOLOGNA) (IT)

(72) Inventor: ALESSANDRO FALZONI, IMOLA (BOLOGNA) (IT)

(21) Appl. No.: 19/153,095

(22) PCT Filed: Feb. 7, 2024
(86) PCT No.: PCT/IB2024/051117

§ 371 Date: Aug. 1, 2025

(30) Foreign Application Priority Data
Feb. 7, 2023 (IT) 102023000001968

(51) Int. Cl. B29B 17/02; B29B 9/06; B29B 17/00; B29B 17/04; B29K 23/00; B29K 67/00; B29K 105/00; B29K 105/26; C08J 3/20; C08L 23/00

(52) U.S. Cl. CPC B29B 17/02; B29B 17/0412; C08J 3/203; C08L 23/00; B29B 9/06; B29B 2017/0015; B29B 2017/0203; B29B 2017/0244; B29B 2017/0268; B29K 2023/00; B29K 2067/003; B29K 2105/0044; B29K 2105/26; C08J 2323/00; C08L 2205/02; C08L 2207/20

(57) ABSTRACT

A method for producing polyolefin food grade recyclates includes the following steps: collecting post-consumer plastic container bales; dividing the material provided by the bales into a first group, formed of material used for beverage purposes, and a second group, formed of material used for non-beverage purposes; shredding the first group of material to obtain plastic flakes; sorting the plastic flakes to derive a first subset, formed of PO flakes and a second subset, formed of PET flakes; processing the first subset of flakes through a polyolefin recycler, to obtain the polyolefin food grade recyclates.

### TECHNICAL FIELD

This invention relates to a method for producing polyolefin food grade recyclates and to a system for treating post-consumer plastic waste to produce polyolefin food grade recyclates.

### BACKGROUND ART

Polyolefins belong to the family of thermoplastic materials which, thanks to their easy processability, low price and good chemical and physical properties, are widely used in the plastics industry. There are mainly four types of polyolefins: LDPE (low density polyethylene), LLDPE (linear low density polyethylene), HDPE (high density polyethylene) and PP (polypropylene); generally speaking, the most important polyolefins are polyethylene (PE) and polypropylene (PP). Polyolefins may have a variety of applications and are widely used in the packaging industry. In particular, polyolefins are widely used in the food packaging industry: plastic caps, for example, are commonly made of polyethylene or polypropylene.

On account of their large-scale application in the packaging industry, polyolefins constitute almost two thirds of all post-consumer plastic waste, and it is therefore necessary to create infrastructure suitable for collecting, sorting and recycling the polyolefins in post-consumer plastic.

Thus, there is a need to recycle post-consumer polyolefins in what is known as closed-loop recycling, whereby the recycled polyolefins are used for packaging (or other) purposes in their subsequent life cycles. Traditionally, in plastic waste treatment plants, bales of plastic from different sources and different primary uses are collected and recycled. In these plants, the post-consumer plastic usually undergoes a recycling process to obtain plastic recyclates, which are then divided into different polymer groups; for example, at the end of the recycling process, the PET-based and polyolefin-based recyclates are separated using different methods, for example, using NIR and/or flotation technology.

One of the problems in the field of polyolefin recycling is, as mentioned above, that the polyolefins in plastic waste come from different sources and, depending on their primary use, may contain different quantities of contaminants; for example, a polyethylene used for detergent bottles can absorb contaminants that might not be removed during the recycling process, making it unsuitable for use in several applications, for example, in the food industry.

Therefore, polyolefin recyclates obtained by known recycling processes might include impurities and odours which exclude them from being used further in several applications because, in order to be suitable for re-use, the polyolefin recyclates must meet predetermined quality requirements which cannot be achieved by recycling mixed plastic waste. For the polyolefin recyclates to be considered at least potentially suitable for coming into contact with food, at least 95% of the starting material must originally have been food grade material. By the term “polyolefin food grade recyclates” used above is meant materials which have already been used in contact with, or as packaging for, food and which can be shown to conform with current food safety standards of authorities such as the EFSA and USFDA, regarding contact with foodstuffs.

The recycling process comprises several steps, such as shredding the plastic waste to obtain flakes, washing the flakes and extruding the washed flakes.

Typical washing processes, however, can remove only the contaminants from the surface of the polymers and are unable to remove the organic substances which have migrated into the polymer. Although the remelting or re-extrusion of the washed flakes could have a further cleaning effect, the level of purity obtained with those methods is usually inadequate for closed-loop recycling; thus, the polyolefin recyclates obtained with those methods might not be suitable for contact with food.

In this context, patent document EP3509811B1 describes a method for producing polyolefin recyclates, specifically HDPE recyclates. In particular, that document describes a method for decontaminating the polyolefin recyclates to obtain polyolefin recyclates having an improved purity grade compared to polyolefin recyclates available on the market to date. However, prior art systems and method for treating post-consumer plastic waste to obtain polyolefin food grade recyclates have some disadvantages and can be improved. In effect, there are several needs in this field.

In particular, there is a need for a post-consumer plastic waste treatment system for producing polyolefin recyclates more efficiently and capable of producing polyolefin food grade recyclates suitable for use in food packaging. Another need in this field is to obtain a post-consumer plastic waste treatment system for producing polyolefin food grade recyclates in a particularly reliable way and which provides information on the properties of the recycled polyolefins to the user and which allows to meet the needs of the user.

Another need is to provide a post-consumer plastic waste treatment system for producing polyolefin food grade recyclates that reduces energy costs and consumption as much as possible.

### DISCLOSURE OF THE INVENTION

The aim of this invention is to provide a system and a method for producing polyolefin food grade recyclates to overcome the above mentioned disadvantages of the prior art.

This aim is fully achieved by the method and the system of this disclosure as characterized in the appended claims.

According to an aspect of it, this disclosure provides a method for producing polyolefin food grade recyclates (that is to say, food safe), suitable for use in direct contact with food. The method includes a step of collecting post-consumer plastic container bales.

The method comprises a step of dividing the material provided by the post-consumer plastic bales into a first group and a second group. The first group of material is formed of material used for beverage purposes. The second group of material is formed of material used for non-beverage purposes.

The method comprises a step of shredding the first group of material to obtain plastic flakes.

The method comprises a step of sorting the plastic flakes to derive a first subset and a second subset. The first subset may be formed of PO (polyolefin) flakes. The second subset may be formed of PET (polyethylene terephthalate) flakes. The second subset may also be formed of other plastic materials. The second subset may therefore comprise flakes that do not include PO. It should be noted that in the step of sorting, the plastic flakes may be divided into more than two subsets.

The method comprises a step of processing the first subset of flakes through a polyolefin recycler. The first subset is processed through the polyolefin recycler to obtain polyolefin food grade recyclates.

Thus, according to an aspect of this disclosure, the post-consumer plastic material collected in the form of bales of post-consumer plastic containers, is divided into materials used for beverage purposes and material used for purposes other than beverages, and the material used for beverage purposes subsequently undergoes a recycling process during which the polyolefin flakes are separated from other plastic flakes and are further recycled in a polyolefin recycler to obtain polyolefin food grade recyclates. It should be noted that the PO flakes are derived from material previously used only for beverages; it does not therefore contain contaminants making it unfit for direct contact with food, and is of a food grade high enough to be used in food packaging; for example, to produce plastic caps. This solution allows obtaining polyolefin recyclates with a high food grade and more efficiently. Moreover, since the post-consumer material used to obtain the polyolefin recyclates was previously in contact only with food, the contaminants can be removed by processes that are less complicated and less expensive and require less energy compared to prior art methods.

Thus, the polyolefin recyclates obtained with this method are very high quality.

In an example, the step of processing the first subset of flakes through the polyolefin recycler includes a step of classifying the first subset of flakes. In an example, the first subset of flakes is classified according to polymer type and/or colour. The first subset of flakes might be classified according to other criteria. It is therefore possible to classify different polyolefins, for example, PP (polypropylene) and PE (polyethylene) to use each type of polyolefin recyclates for a specific application. The flakes can also be separated into different groups based on colour, so that the polyolefin recyclates obtained from each group are uniformly coloured or similar in colour.

The step of processing the first subset of flakes through the polyolefin recycler also includes a step of extruding the first subset of flakes. More specifically, the flakes of the first subset are fed into one or more extruders; inside the extruder, the flakes are melted and then decontaminated and regranulated. In particular, the extruder must be provided with filters to remove undesirable components from the molten flakes. The molten flakes can therefore be degassed, and/or filtered, and/or purified. On account of the high temperatures used, the step of extruding allows eliminating possible contamination due to volatile substances in the flakes.

The step of processing the first subset of flakes through the polyolefin recycler also includes a step of decontaminating and purifying the flakes after extrusion.

The step of processing the first subset of flakes through the polyolefin recycler also includes a step of pelletizing the extruded, purified flakes to obtain polyolefin food grade granules.

In an example, in the step of processing the first subset of flakes through the polyolefin recycler, additives are added to the extruded flakes in order to enhance the food grade of the granules obtained.

In an example, the additives may include virgin polyolefins whose viscosity is similar or different to that of the recycled material, antioxidant additives or additives of other kinds, such as lubricants or colouring substances. In another example, the additives may include other materials which enhance the food grade of the granules obtained.

In an example, the polymer is classified using near-infrared (NIR) spectroscopy systems. In another example, the polymer may be classified using other technologies.

In an example, the method comprises a step of preselecting. The step of preselecting is applied to the first subset of flakes. In an example, the step of preselecting is applied to the first subset of flakes prior to the step of processing the first subset of flakes. In other words, preselection can be applied to the first subset of flakes before the flakes are conveyed to the polyolefin recycler. In another example, the first subset of flakes may first be conveyed to the polyolefin recycler and then subjected to the step of preselecting. The step of preselecting includes inspecting the first subset to identify undesired items and/or possible contaminations in the first subset of flakes. In an example, the step of preselecting is carried out though an artificial intelligence visual control system, and/or olfactory sensors for identifying contaminants. In another example, the visual inspection may be carried out by an operator. Therefore, the step of preselecting may be automatic or manual. In an example, the step of preselecting is a batch process. Preselection ensures that undesired or contaminated items do not enter the polyolefin recycler. In an example, the method comprises a step of inspecting the food grade of the polyolefin recyclates, after the step of processing so as to verify that the food grade corresponds to a predetermined grade.

In an example, the method comprises a step of collecting the plastic caps for reusable or refillable beverage bottles. The method may also comprise a step of shredding the plastic caps to obtain plastic cap flakes. The plastic cap flakes are classified in the first subset of flakes.

The first subset of flakes processed through the polyolefin recycler also includes the plastic cap flakes. In an example, therefore, the first subset of post-consumer material derived from the bales of post-consumer plastic containers and the flakes derived from the plastic caps are processed to obtain the polyolefin food grade recyclates. It should be noted that both the plastic cap flakes and the first subset of post-consumer material derived from the bales of post-consumer plastic containers are polyolefins previously used only for beverages and thus have a high food grade. The plastic cap flakes and the first subset of post-consumer material derived from the bales of post-consumer plastic containers can be processed through the polyolefin recycler together or separately. It should be noted that the plastic caps are made from polyolefins.

In an example, the division of the material into the first group and the second group is applied to the post-consumer plastic container bales collected, so that each post-consumer plastic container bale collected belongs either to the first group or to the second group. In this example, the bales formed of post-consumer plastic containers used for beverage purposes are collected separately from those formed of post-consumer plastic containers used for non-beverage purposes, hence each bale belongs either to the first group or to the second group. In another example, each post-consumer plastic container bale may include material used for beverage purposes, as well as material used for non-beverage purposes; in this example, for each bale, the material used for beverage purposes and the material used for non-beverage purposes are divided into the first group and the second group, respectively.

In an example, the step of processing the first subset of flakes through the polyolefin recycler comprises a step of further grinding the first subset of flakes to obtain homogenized flakes.

The step of processing the first subset of flakes through the polyolefin recycler may comprise a step of demetallizing the first subset of flakes.

The step of processing the first subset of flakes through the polyolefin recycler may comprise a step of washing the first subset of flakes.

The step of processing the first subset of flakes through the polyolefin recycler may comprise a step of deodorizing. Deodorization may be performed on the first subset of flakes after the step of shredding or on the polyolefin granules obtained after the step of pelletizing. It should be noted that deodorization is performed on the unmelted (hence solid) flakes. During deodorization, the flakes are heated (for example, to 60° C.). Some volatile compounds which can cause undesirable odours can be removed during the step of decontaminating, carried out on the flakes after extrusion; the purpose of decontamination, however, is also to remove contaminants other than volatile compounds.

In this disclosure, therefore, the term “deodorization” is used to denote the process carried out before extrusion and the term “decontamination” to denote the process carried out after extrusion.

According to an aspect of it, this disclosure provides a system for treating post-consumer plastic waste to produce polyolefin food grade recyclates, suitable for use in direct contact with food. The system for treating post-consumer plastic waste to produce polyolefin food grade recyclates (“the system” for short) comprises an input stage. The input stage receives post-consumer plastic container bales. The system comprises a division centre. The division centre is configured to divide the material provided by the post-consumer plastic bales into a first group and a second group. The first group of material is formed of material used for beverage purposes. The second group of material is formed of material used for non-beverage purposes.

The system comprises a shredder. The shredder is configured to shred the first group of material to obtain plastic flakes.

The system comprises a sorting unit. The sorting unit is configured for sorting the plastic flakes to derive a first subset and a second subset. In an example, the first subset is formed of PO flakes. The second subset may be formed of PET flakes.

The system includes a polyolefin recycler. The polyolefin recycler is configured for processing the first subset of flakes to obtain the polyolefin food grade recyclates.

In an example, the input stage of the system receives plastic caps used in reusable or refillable beverage bottles. The shredder may also be configured for shredding the plastic caps to obtain plastic cap flakes. The plastic cap flakes are classified in the first subset of flakes. The first subset of flakes processed through the polyolefin recycler also includes the plastic cap flakes. The system may also comprise a preselection unit. In an example, the preselection unit is configured to receive the first subset of flakes upstream of the polyolefin recycler. The preselection unit is configured to inspect the first subset of flakes to identify undesired items and/or possible contaminants in the first subset of flakes.

The system may comprise a final inspection unit. The final inspection unit is configured to inspect the food grade of the polyolefin recyclates, downstream of the polyolefin recycler to verify that the food grade corresponds to a predetermined grade.

The polyolefin recycler comprises a polyolefin shredder. The polyolefin shredder of the polyolefin recycler is configured for further grinding the first subset of flakes to obtain homogenized flakes.

The polyolefin recycler may include a demetallization unit. The demetallization unit is configured for demetallizing the first subset of flakes.

The polyolefin recycler includes a washing unit. The washing unit is configured for washing the first subset of flakes.

The system may also include a sieving unit to eliminate dust and pieces of plastic which are too small to be effectively separated; for example, the mesh size of the sieve is less than 5 mm, or less than 3 mm or less than 2 mm.

The system may also include an elutriation unit in which the remains of bottle labels and dust are removed by an air flow. Preferably, the sieving unit and the elutriation unit are located upstream of the preselection unit. Alternatively, the sieving unit and the elutriation unit may form part of the preselection unit.

The polyolefin recycler includes a classification unit. The classification unit is configured for classifying the first subset of flakes. In an example, the classification unit is configured for classifying the first subset of flakes based on polymer type and/or colour.

The polyolefin recycler includes an extruder. The extruder is configured for extruding the first subset of flakes.

The polyolefin recycler includes a decontamination unit. The decontamination unit is configured for decontaminating and purifying the extruded flakes.

The polyolefin recycler includes an enhancement unit. The enhancement unit is configured for adding additives to the extruded flakes in order to enhance the food grade of the granules obtained.

The polyolefin recycler includes a pelletizing unit. The pelletizing unit is configured to obtain polyolefin food grade granules from the extruded flakes. The polyolefin recycler may include a deodorization unit. In an example, the deodorization unit is located upstream of the extruder. The deodorization unit is configured for deodorizing the first subset of flakes. In another example, the deodorization unit may be located downstream of the extruder. In this example, the deodorization unit is located downstream of the pelletizing unit and is configured for deodorizing the polyolefin granules.

According to another aspect of the present description, the method for producing polyolefin food grade recyclates, suitable for use in direct contact with food can include a step of collecting post-consumer polyolefin-based food grade plastic. Post-consumer polyolefin-based food grade plastic is formed of material used for beverage purposes. In one example, post-consumer polyolefin-based food grade plastic can be supplied from bales of post-consumer plastic containers. In one example, said bales of post-consumer plastic containers are divided into a first group and a second group, wherein the first material group is formed by material used for beverage purposes and the second material group is formed by material used for uses other purposes than beverage purposes. In one example, post-consumer polyolefin-based food grade plastic may be derived from the first group, consisting of material used for beverage purposes, according to one or more aspects of the present disclosure. The method includes a step of shredding post-consumer polyolefin-based food grade plastic to obtain flakes. The method includes a step of processing the flakes through a polyolefin recycler, to obtain the polyolefin food grade recyclates. The method includes an inspection step of post-consumer polyolefin-based food grade plastic to obtain a physical property parameter. In one example, the physical property parameter is representative of a melting index of post-consumer polyolefin-based food grade plastic. The method includes a step of separating post-consumer polyolefin-based food grade plastic, based on the physical property parameter. In particular, post-consumer polyolefin-based food grade plastic is separated into a plurality of groups. Furthermore, a respective physical property parameter is attributed to each group of the plurality of groups. The method includes a step of providing a pack. The method includes a step of introducing a predetermined amount of the polyolefin food grade recyclates into the pack. The polyolefin food grade recyclates of the predetermined quantity of the polyolefin food grade recyclates placed in the pack are homogeneous with respect to the physical property parameter. The method includes a step of providing each package with information relating to the physical property parameter of the polyolefin food grade recyclates contained in the package.

Please note that the Polyolefin flakes are derived from the material previously used only for beverage purposes, therefore it has no contamination that excludes the possibility of direct contact with food and has a food grade high enough to be used in food packaging; for example, to produce plastic caps. Therefore, it is possible to obtain the polyolefin recyclates of high food grade and with greater efficiency. Furthermore, considering that the post-consumer material used to obtain the recycled polyolefins has been previously in contact only with food, it is possible to remove such contaminations with less complicated processes that require less cost and energy consumption compared to prior art methods. Therefore, the recycled polyolefins obtained by this method have a particularly high quality.

Additionally, post-consumer plastic is inspected and sorted based on the physical property parameter, and the food-grade recycled polyolefins are placed into packs that provide information relating to the physical property parameter of the recycled polyolefins. This solution allows the user to have information on the property of the recycled polyolefins inside the packs (for example on the melting index of the recycled polyolefins) which is important regarding the process in which the recycled polyolefins are subsequently used (for example injection or compression molding) to obtain a final product. Therefore, the user can choose the packaging of recycled polyolefins based on their needs.

Please note that this aspect (collection of post-consumer polyolefin-based food grade plastic, separating it according to the physical property parameter and provide information related to the physical property parameter of the polyolefin food-grade recyclates contained in the pack, can be combined with other steps (one or more) of the method, according to the present disclosure; however, it is not inextricably linked to such steps. Furthermore, post-consumer polyolefin-based food grade plastic formed from material used for beverage purposes can be derived according to one or more aspects of the present disclosure (e.g. from the separation of container bales as explained in this disclosure), or from other sources and methods (e.g. from the collection of post-consumer plastic caps). Thus, according to one aspect of the present disclosure the first subset provides food grade polyolefin-based post-consumer plastic flakes formed from material used for beverages.

In one example, the physical property parameter is derived through an inspection performed on the flakes.

In one example, the flakes are separated based on color. Furthermore, the flakes can be divided based on the polymer type. The physical property parameter can be obtained based on the color of the scales.

In particular, a melting index range can be associated with post-consumer plastic based on color, as usually in this sector a specific melting index range is associated with each color. In one example, food-grade polyolefin-based post-consumer plastic prior to the shredding step is separated based on the primary application and the physical property parameter is obtained based on the primary application. Note that in another example, flakes can be divided based on primary application. By “primary application” we mean the application of post-consumer plastic during its consumption (for example plastic previously used as a cap in sparkling drinks, in still drinks, or plastic used as a milk bottle, etc.). Please note that in the plastic industry in each application a plastic with certain properties (in particular, melting index) is used; therefore, knowing the primary application of the post-consumer plastic that provides the flakes allows you to assign a melting index range (and other properties) to that plastic.

It may be envisaged that the flakes are inspected and divided both on the basis of color and on the basis of primary use or on the basis of one of the aforementioned criteria.

In particular, sorting the flakes based on the color and/or primary application of the plastic that supplies the flakes allows one to estimate a range of polymer melting index, separating the flakes into different groups based on the estimated melting index for each color and/or primary application and attribute a respective physical property parameter to the flakes of each group. This sorting is particularly simple, reliable and cost-effective. The method may include a step of separating the flakes, based on the physical property parameter, into a plurality of subsets. Note that the physical property parameter can be obtained according to any of the above-mentioned criteria. In each subset the flakes are homogeneous with respect to the physical property parameter. In other words, the flakes of each subset have a specific range for the value of the physical property parameter, which is the same for all flakes of that subset.

The method may include a step of processing, separately, each subset of the plurality of subsets through the polyolefin recycler, to obtain a respective plurality of polyolefin food grade recyclates subsets.

In one example, the physical property parameter is obtained by performing a melting index test on food grade recycled polyolefins and/or flakes. Please note that this test is performed according to standards known in the industry.

It can be envisaged that the physical property parameter is obtained either on the basis of inspection of the flakes according to one or more methods explained above or by carrying out a melting index test on the flakes and/or on the polyolefin food grade recyclates, or on the basis of only one of these methods.

In one example, the physical property parameter information related to the polyolefin food grade recyclates contained in the pack includes information on how the physical property parameter is obtained. For example, it may be envisaged to provide information explaining the physical property parameter on the basis of which polyolefins food grade recyclates are divided has been obtained by separation of the flakes on the basis of color.

In one example, the information related to physical property parameter of the polyolefin food-grade recyclates contained in the pack includes operation information representative of the application of the polyolefin food-grade recyclates in a molding process to obtain a final product derived from the polyolefin food grade recyclates in each pack. This operation information is defined according to the operating conditions of the molding process.

In one example, the operation information includes information on a suggested percentage of polyolefin food-grade recyclates for use in combination with virgin polymer.

The method may include a flake extrusion step. The method includes a pelletizing step of the extruded flakes to obtain food-grade polyolefin granules. Therefore, according to an example, recycled polyolefins are recycled polyolefin granules.

According to an aspect of the present description, the post-consumer plastic waste treatment system for producing polyolefin food grade recyclates, suitable for use in direct contact with food includes an input unit. The input unit is configured to receive post-consumer polyolefin-based food grade plastic formed of material used for beverage purposes. The system includes a shredder. The shredder is configured to shred food-grade polyolefin-based post-consumer plastic into flakes. The system includes a polyolefin recycler. The polyolefin recycler is configured to process the flakes into polyolefin food grade recyclates.

The system includes an inspection center to inspect the post-consumer polyolefin-based food grade plastic to obtain a physical property parameter. The physical property parameter is representative of a melting index of the post-consumer polyolefin-based food grade plastic. The system includes a separation center, the separation center is configured to separate the post-consumer polyolefin-based food grade plastic, based on the physical property parameter, into a plurality of groups, wherein a respective physical property parameter is attributed to each group of the plurality of groups. The system includes a packaging unit to introduce a predetermined amount of the polyolefin food grade recyclates into the package. The polyolefin food grade recyclates of the predetermined quantity of the polyolefin food grade recyclates placed in the pack are homogeneous with respect to the physical property parameter.

The system includes a labeling unit to provide each package with information regarding the physical property parameter of the polyolefin food grade recyclates contained in the pack.

Please note that this aspect can be combined with other features (one or more) of the system according to the present disclosure; however, it is not inextricably linked to such features.

In one example, the inspection center is configured to perform an inspection on the flakes to obtain the physical property parameter.

In an example, at least one of the following conditions is true:
the flakes are separated based on color and the physical property parameter is obtained based on the color of the flakes,
post-consumer polyolefin-based food grade plastic is separated based on the primary application before the shredding stage and the physical property parameter is obtained based on the primary application. Therefore, the above-mentioned conditions can be verified at the same time or one in the absence of the other.

In one example, the separation center is configured to separate the flakes, based on the physical property parameter, into a plurality of subsets. In each subset the flakes are homogeneous with respect to the physical property parameter. The polyolefin recycler is configured to process each subset of the plurality of subsets, separately, to obtain a respective plurality of food grade recycled polyolefin subsets. In one example, the inspection center is configured to perform a melting index test on food grade recycled polyolefins and/or flakes to obtain the physical property parameter.

In one example, the physical property parameter information related to the physical property parameter of the polyolefin food grade recyclates contained in the pack includes information on how the physical property parameter is obtained.

In one example, the physical property parameter information related to the physical property parameter of the polyolefin food grade recyclates contained in the pack includes operational information representative of the application of the polyolefin food grade recyclates in a molding process to obtain a final product derived from the polyolefin food grade recyclates of each pack depending on the operating conditions of the molding process. The operating information includes information on a suggested percentage of polyolefin food grade recyclates for use in combination with virgin polymer. In one example, food grade recycled polyolefins are in the form of granules.

### BRIEF DESCRIPTION OF DRAWINGS

These and other features will become more apparent from the following description of a preferred embodiment, illustrated by way of non-limiting example in the accompanying drawings, in which:

FIGS. 1A and 1B illustrate the production and separation phases of recycled polyolefins according to one or more aspects of the present description;

FIGS. 2A, 2B and 3 represent a process for closed-loop recycling of post-consumer plastic waste through a post-consumer plastic waste treatment system according to this disclosure, for producing polyolefin food grade recyclates, suitable for use in direct contact with food;

FIGS. 4A and 4B illustrate the polyolefin recycler used in the post-consumer plastic waste treatment system;

FIG. 5 illustrates the post-consumer plastic waste treatment system for producing polyolefin food grade recyclates;

FIG. 6 illustrates the viscosity of the HDPE after several process cycles;

FIGS. 7 and 8 illustrate the results of experiments conducted on the caps.

### DETAILED DESCRIPTION OF PREFERRED EMBODIMENTS OF THE INVENTION

With reference to the accompanying drawings, the numeral 1 denotes a post-consumer plastic waste treatment system for producing polyolefin food grade recyclates. The polyolefin food grade recyclates are suitable for use in direct contact with food. The post-consumer plastic waste treatment system 1 for producing polyolefin food grade recyclates suitable for use in direct contact with food (“the system” for short) includes an input stage I for receiving post-consumer plastic container bales B. The post-consumer plastic container bales B (“the bales” for short) include plastic containers and caps. In particular, the bales may include both plastic used for beverage purposes (or food packaging generally) and plastic used for other purposes. In an example, the post-consumer plastic used for beverage purposes is received at the input stage I separately from the plastic used for non-beverage purposes; thus, in an example, each bale B received at the input stage I contains either plastic used for beverage purposes or plastic used for non-beverage purposes. The plastic used for beverage purposes may be collected in smart waste bins (that is, reverse vending machines) which collect empty beverage bottles (or bottles used to contain food products generally) or at points of sale where consumers pay a small deposit which is returned to them when they bring the empty container back after using its contents). The plastic used for beverage purposes may also be collected at other points, as long as it is guaranteed that the plastic containers have been used only for food products. The post-consumer plastic used for other purposes may be collected together with urban waste. This plastic is mixed plastic, hence post-consumer plastic which has been used for different purposes and has come into contact with different materials (both food and non-food). Generally speaking, the bales B are formed by a post consumer material collection centre POC, where empty plastic containers CO are collected after being used by users U. In an example, the input stage I of the system 1 also receives post-consumer plastic caps C. In an example, these plastic caps are used in refillable beverage bottles. These plastic caps may also include caps that are separate from the bodies of the plastic beverage bottles. The plastic caps C, after being used by users U, are collected in a post consumer material collection centre POC. These plastic caps are mainly made from polyolefins. Preferably, the plastic caps are collected separately from the bales B. As explained above, the bales provide post-consumer plastic material. This material is divided into a first group P1, formed of material used for beverage purposes, and a second group P2, formed of material used for non-beverage purposes. The first group P1 constitutes post-consumer polyolefin-based food grade plastic formed of material used for beverage purposes. post-consumer polyolefin-based food grade plastic is collected in an input unit and if the first group contains non-polyolefin-based plastic, a separation step is provided to obtain only the post-consumer polyolefin-based food grade plastic formed of material used for beverage purposes. This plastic is subsequently shredded. Subdividing the material into the first and the second group is carried out at a division centre 2 of the system 1. When the system receives the plastic caps C in addition to the bales B, the step of dividing the material is carried out only on the bales, since the plastic caps collected are from beverage bottles and are made only from material used for beverage purposes. Thus, the first group of material includes the plastic caps and the material used for beverage purposes provided by the bales B. The division of the material into the first group P1 and the second group P2 is applied to the post-consumer plastic container bales B collected, so that each post-consumer plastic container bale B collected belongs either to the first group P1 or to the second group P2. The first group P1 includes only material used for beverage purposes (or for packaging food generally), hence is less contaminated than the second group P2; the first group P1, therefore, is more suitable for use in the recycling of polyolefins. After leaving the division centre 2, the first group of material enters a plastic recycler R. In particular, in the plastic recycler R, the first group undergoes several processes. For example, the plastic recycler R has a shredder 3 for shredding the first group of material to obtain plastic flakes. In particular, the shredder 3 shreds post-consumer polyolefin-based food grade plastic to obtain flakes The plastic flakes are washed in a washing stage. The washing stage reaches high temperatures to remove contaminants from the post-consumer plastic flakes. In an example, the second group of material may be processed separately from the first group of material P1, in a plastic recycler similar to the one used to process the first group of material. In this example, the washed flakes of the second group of material P2 are collected for use in applications where food grade polyolefins are not required.

On leaving the plastic recycler R, the washed flakes of the first group P1 are conveyed to a sorting unit 4, where the plastic flakes are divided into a first subset S1, formed of polyolefin flakes, and a second subset S2, formed of PET flakes. It should be noted that besides PET, the second subset may include flakes of other plastic materials. Preferably, the step of sorting the plastic flakes to derive the first and the second subset of flakes is carried out by flotation separation and is based on specific gravity. In this method, the plastic flakes of the first group P1, after being washed, are separated by flotation in water (or other liquid); since the PET (the second subset) is denser than water, while the polyolefins (the first subset) are less dense than water, the second subset S2 sinks and the first subset floats. The flakes are then dried. The step of sorting the plastic flakes to derive the first and the second subset of flakes may be carried out by other methods.

The first subset of flakes is then processed through a polyolefin recycler 6 to obtain the polyolefin food grade recyclates. In particular, the polyolefin recyclates obtained from the polyolefin recycler 6 are in the form of granules. Furthermore, the plastic caps are also shredded in the shredder 3 to obtain plastic cap flakes. The plastic cap flakes may be washed in the washing stage. The plastic cap flakes C may be processed in the plastic recycler R separately from, or together with, the first material P1. It should be noted that the plastic cap flakes are classified in the first subset of flakes, so the first subset of flakes processed through the polyolefin recycler 6 also includes the plastic cap flakes.

In another example, the plastic caps C may be fed directly to the polyolefin recycler 6 without undergoing any other processes in the plastic recycler R before entering the polyolefin recycler 6. The system 1 includes a preselection unit 5, where a step of preselecting is applied to the first subset of flakes S1 before it is conveyed to the polyolefin recycler 6. During the step of preselecting, the first subset of flakes is inspected to identify undesired items and/or possible contaminations in the first subset of flakes. The step of preselecting may comprise a visual inspection carried out by an operator or by an artificial intelligence system. Contaminations or unpleasant odours are identified using olfactory sensors or gas chromatography. Other methods can be used in the step of preselecting. After being inspected in the preselection unit 5, the first subset is conveyed to an entrance 601 of the polyolefin recycler 6. Thus, the first subset of flakes, which includes the plastic cap flakes and the flakes derived from the first group of material P1, is fed to the polyolefin recycler 6. The polyolefin recycler 6 includes a polyolefin shredder 602. In particular, the first subset of flakes may be further shredded in the polyolefin shredder 602 to obtain homogenized flakes.

The polyolefin recycler 6 includes a demetallization unit 603, where the first subset of flakes is demetallized. The demetallization of the first subset of flakes is carried out by magnetic means or through eddy currents.

The first subset of flakes is washed in a washing unit 604 of the polyolefin recycler 6. The washed flakes of the first subset are classified on the basis of polymer type and/or colour of the flakes. This classification occurs in a classification unit 605 of the polyolefin recycler 6 and may be carried out through NIR systems, optical systems, by flotation separation or by centrifuge. The classification unit 605 includes a polymer separator 605A, where the flakes are classified on the basis of polymer type. The classification unit 605 includes a colour separator 605B, where the flakes are classified on the basis of their colour.

The flakes which have been classified are then purified in a refining stage 606 of the polyolefin recycler 6. The refining stage includes an extruder 606A in which the first subset is extruded. The refining stage includes a decontamination unit 606B, where the extruded flakes are filtered and purified to remove volatile substances and other contaminants.

The refining stage 606 may also include an enhancement unit 606C. In particular, in the enhancement unit, additives are added to the extruded flakes in order to enhance the food grade of the granules obtained. The additives include virgin polyolefins and/or anti-oxidants.

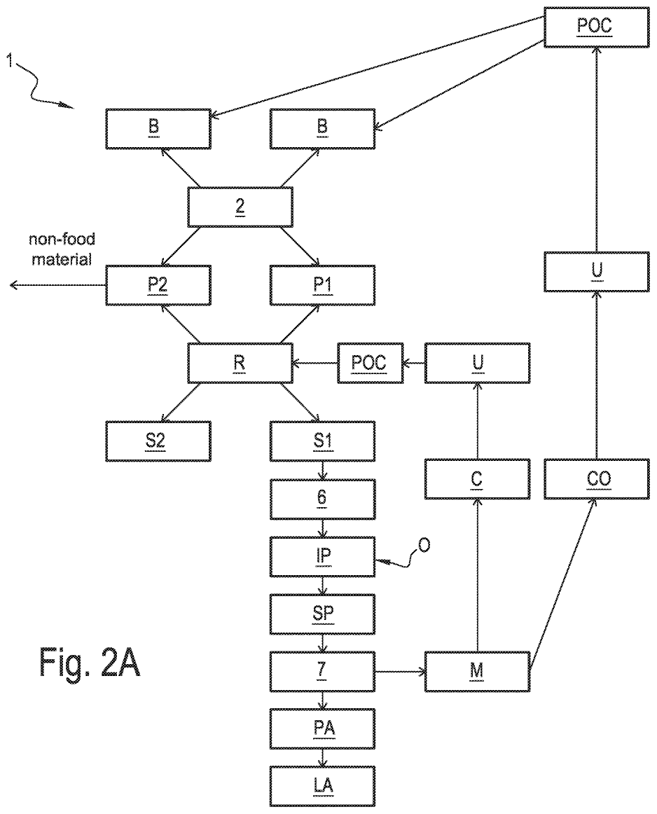

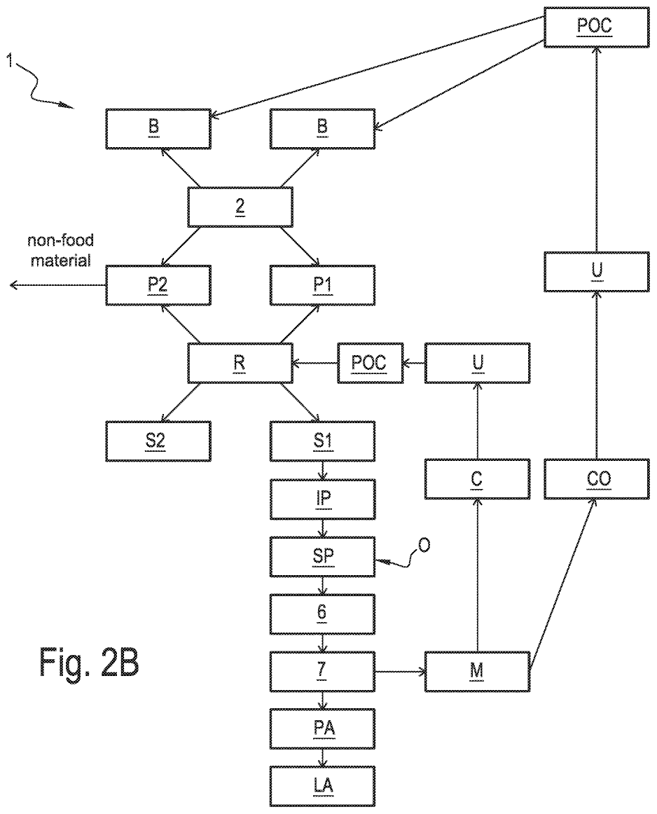

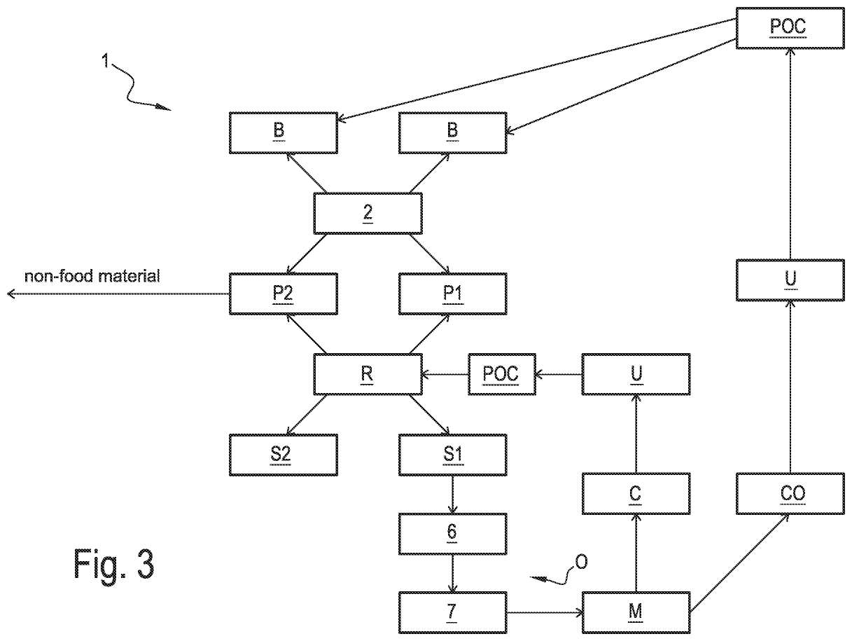

The polyolefin recycler 6 includes a pelletizing unit 607, where the extruded flakes are transformed into polyolefin food grade granules in the pelletizing unit 607. The polyolefin recycler 6 may comprise a deodorization unit D. The deodorization unit D may be located before the refining stage 606, hence before the extruder 606A. In an example, therefore, the first subset of flakes is deodorized before being extruded. In an example, the deodorization unit is located after the washing unit. In other examples, the deodorization unit may be located downstream of the entrance 601 of the polyolefin recycler, or downstream of the polyolefin shredder 602, or downstream of the demetallization unit 603, or downstream of the classification unit 605. In another example, the deodorization unit may be located upstream of the polyolefin recycler 6. In another example, the deodorization unit D may be located downstream of the pelletizing unit 607 and deodorizes the polyolefin granules (FIG. 2B). The system 1 comprises a final inspection unit 7. The final inspection unit 7 receives the polyolefin recyclates at an exit 608 of the polyolefin recycler 6. The final inspection unit 7 inspects the polyolefin recyclates to verify that the food grade corresponds to a predetermined grade. The final inspection unit 7 is located at an exit O of the system. The granules obtained at the exit O of the system are then conveyed to a production unit M, where they are used for new products, for example, new containers and/or plastic caps made from the granules of polyolefin recyclates.

Usually, plastic caps are made from high-density polyethylene (HDPE). HDPE can be processed several times without losing its essential properties and can therefore be recycled several times.

This has been confirmed experimentally. In this context, the Applicant has conducted experiments on HDPE (virgin HDPE) in order to assess the properties of HDPE after 1 or more process cycles.

In these experiments, the virgin HDPE was subjected to a circular process which comprises: a step of extruding virgin HDPE, a step of compression moulding the extruded HDPE to obtain plastic caps, a step of shredding the plastic caps to obtain plastic flakes from the caps and a step of feeding the plastic cap flakes to the extruder. This cycle is repeated several times. The cycle was repeated between 7 and 20 times. The extruder is fed preferably with 100% flakes. It is also possible, however, to use another percentage of flakes (for example, 50%).

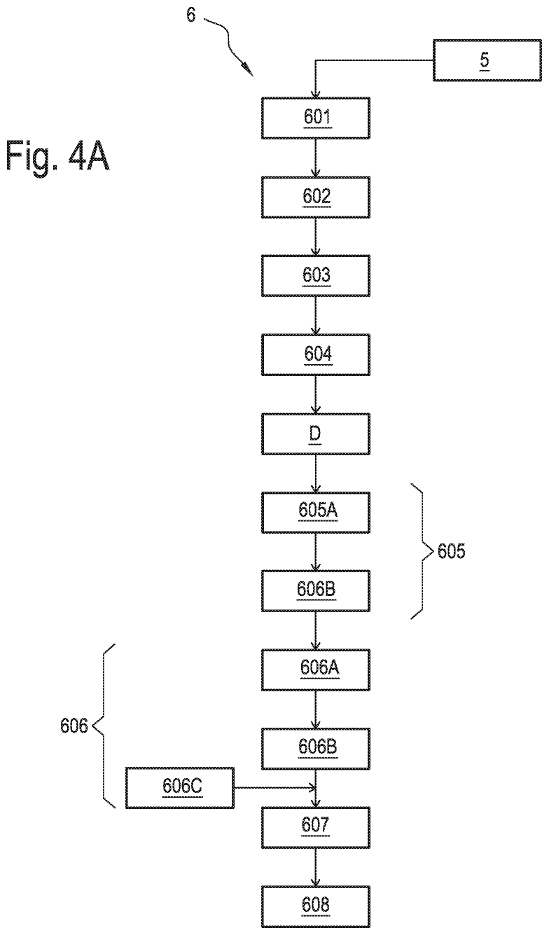

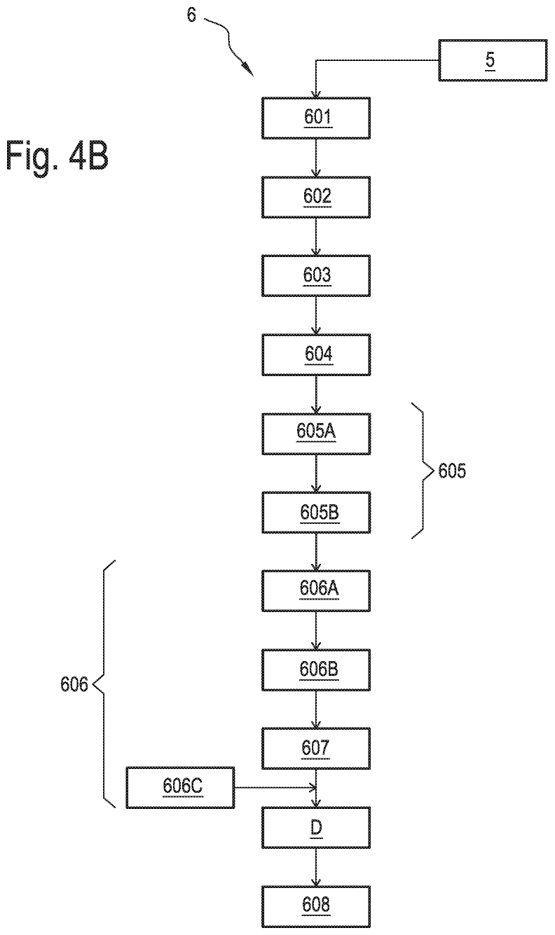

As may be noted in FIG. 4, the viscosity of the HDPE after several process cycles is effectively similar to that of the virgin HDPE. In particular, the graph of FIG. 4 shows the viscosity as a function of the shear rate for virgin HDPE and HDPE after 2, 4 and 7 process cycles.

It may be noted that the lines for different samples of HDPE (virgin, processed 2, 4 and 7 times) are almost overlaid on one another, showing that the viscosity of the HDPE after the aforesaid process cycle does not change.

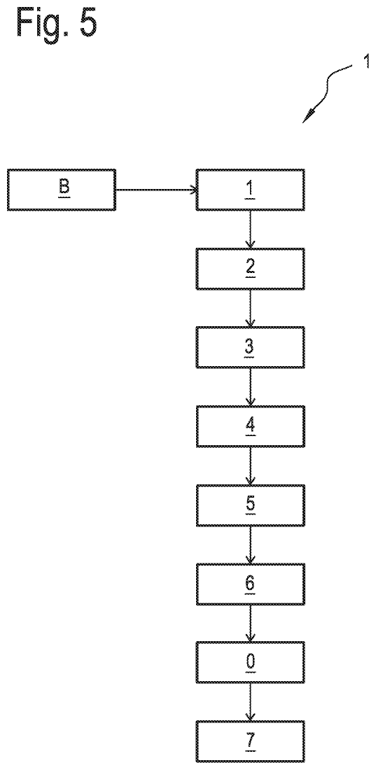

The dimensions of the caps were also measured, in particular, the ovality and diameter of caps made from the virgin HDPE and the processed HDPE (1-7 cycles) and the results (shown in the tables of FIG. 5) show that these parameters too remain almost the same throughout the processing of the HDPE.

It may therefore be concluded that HDPE can be processed many times without losing its main properties (viscosity and dimensions and, in particular, the properties fundamental for the production of plastic caps). In another experiment, HDPE flakes were obtained from post-consumer caps belonging to beverage bottles. The caps were collected in Italy and from mixed municipal waste. The caps belonged to beverage bottles (of all kinds). The caps were also collected from cap-only collection points.

The flakes were then sorted by colour. 100% of the flakes were used in a moulding process to obtain caps from the flakes.

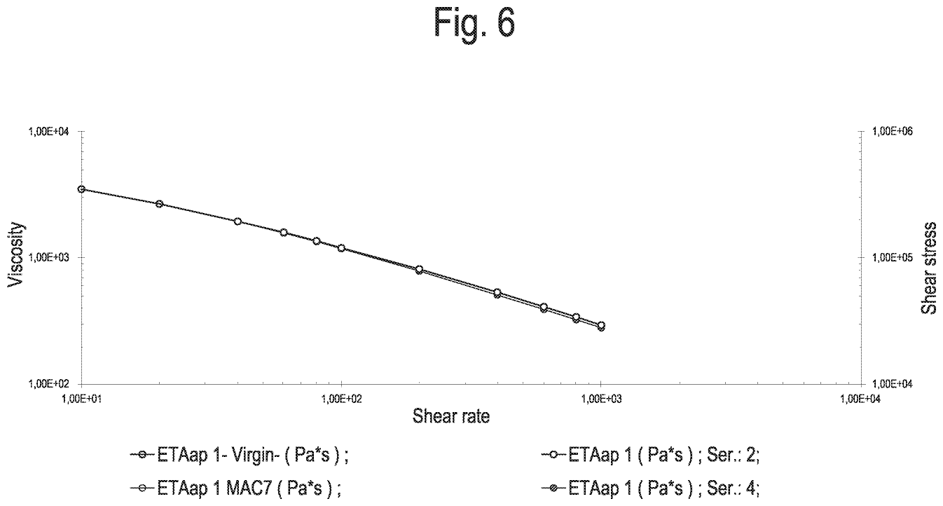

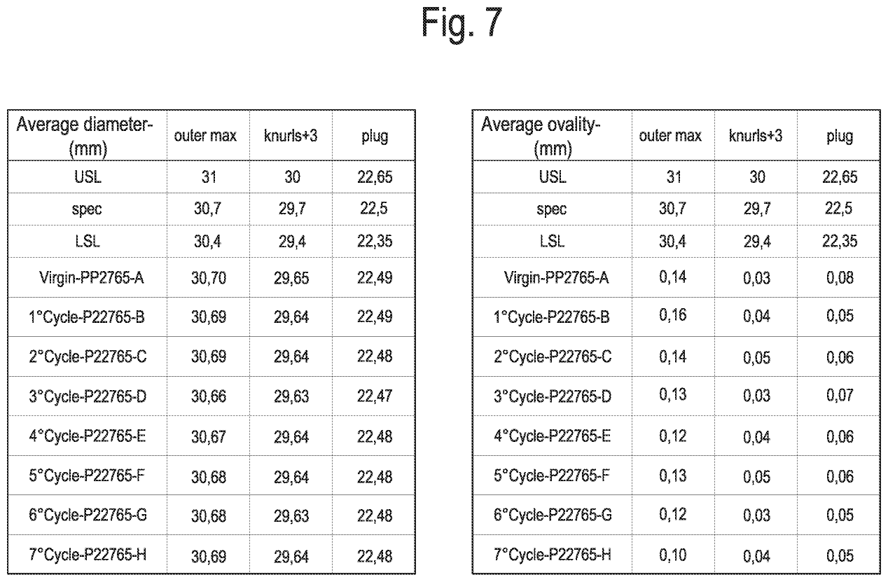

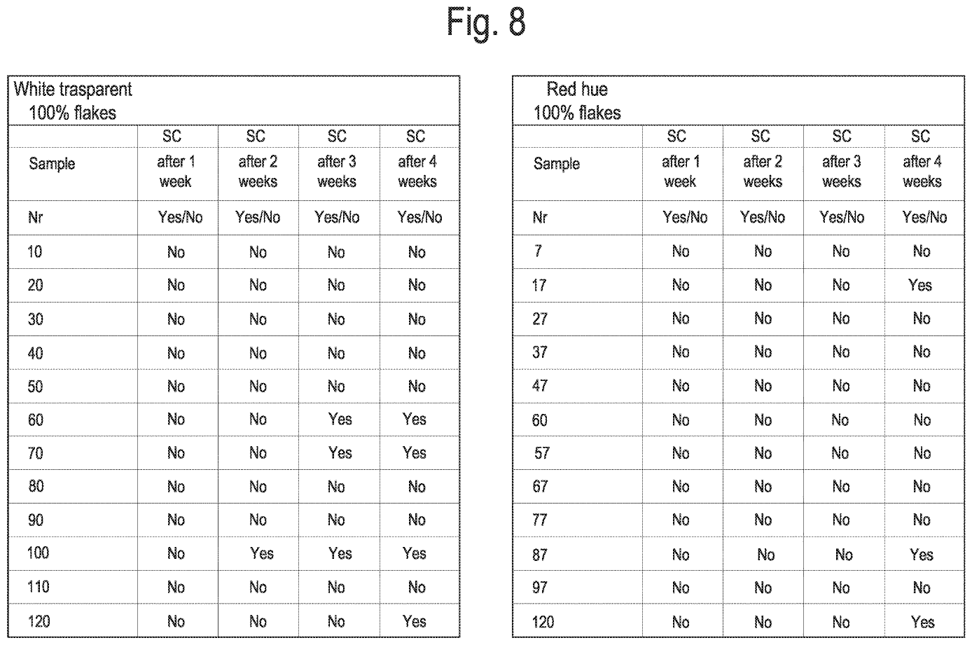

Environmental stress cracking (ESC) of the caps in CO2 was then measured. For this purpose, the caps were placed on bottles filled with fizzy drinks and the bottles were then placed in storage at 50° C. The results are shown in FIG. 6. It may be noted that the caps made from white transparent flakes proved less resistant over time than the red hue flakes.

The white plastic flakes were mainly from caps used for bottles of water. The red hue plastic flakes were mainly from caps used for bottles of fizzy drinks. Caps for fizzy drinks are made using plastic with high stress cracking resistance properties.

In an example, the thickness of the cap walls whose stress cracking resistance was measured is increased by approximately 10-20%. In particular, the thickness of the lower (bottom) wall was increased.

Thus, the experiment showed that the post-consumer plastic keeps its initial properties to a large extent and in this case, the red hue caps provide the post-consumer plastic that is the most promising for the production of beverage caps (and in particular for fizzy drinks).

It was concluded that HDPE (both virgin and post-consumer) has the potential to be used in a circular process and recycled many times. There are, however, factors which may have a significant negative impact on the recycling of HDPE.

For example, the presence of impurities such as paper and fibres may cause undesirable odours in the HDPE recyclate.

The impurities may also initiate stress cracking in the caps made from post-consumer HDPE. Moreover, the type of virgin HDPE used to make the caps and the additives used in the cap production process may have an impact on the quality of the caps subsequently made from post-consumer HDPE.

According to one aspect of the present disclosure, the post-consumer polyolefin-based food grade plastic is inspected in an inspection center IP to obtain a physical property parameter representative of a melting index of the post-consumer polyolefin-based food grade plastic. Preferably the physical property parameter includes a range for the melting index value of the post-consumer polyolefin-based food grade plastic or the exact value of the melting index.

melting index of a polymer is the index of the ease of flow of the molten polymer; its measurement is carried out by loading the molten polymer at a certain temperature into a heated cylinder to which a small cylinder (diameter 2.095 mm and length 8 mm) is fixed, which exerts a constant force and makes the polymer flow through a capillary; the mass (expressed in grams) of polymer released in 10 minutes corresponds to the value of the Melt Flow Index.

The greater the mass of leaked material, the greater the Melt Flow Index and the lower the viscosity of the polymer.

Furthermore, different sets of melt index ranges can be provided based on the magnitude of stress cracking, since the magnitude of stress cracking of a polymer is related to the value of the melt index.

Stress cracking for thermoplastic polymers is defined as “an external or internal crack in a plastic caused by tensile stresses below its short-term mechanical strength”.

For example, a division of the melt index value could be as follows:

### Type 1

melt index (2.16 kg 90° C.): 0.4-0.85 g/10 minutes
density: 0.95-0.965 g/cm\hat{ }3

### Type 2

melt index (2.16 kg 90° C.): 1.4-3.3 g/10 minutes
density: 0.95-0.962 g/cm\hat{ }3

### Type 3

melt index (2.16 kg 90° C.): 3.3-8.5 g/10 minutes
density: 0.95-0.962 g/cm\hat{ }3

A stress cracking magnitude can be estimated at each of the above-mentioned groups for the melting index value. After the physical property parameter is obtained, the post-consumer polyolefin-based food grade plastic is separated, in a separation center SP, according to the physical property parameter, into a plurality of groups, in which a respective physical property parameter is attributed to each group of the plurality of groups. Therefore, each group has a relative melting index range or the same melting index value, and the physical property parameter of each group is different from that of the other group. The post-consumer polyolefin-based food grade plastic is shredded and then processed in the polyolefin recycler 6. The inspection can take place after shredding, i.e. on the flakes, or after processing the flakes on the recycled polyolefins (preferably granules), or before shredding.

It is also possible to do more than one inspection phase before or after shredding and before or after flake processing.

In one example, the physical property parameter is derived through an inspection performed on the flakes. In one example, the flakes are separated based on color and the physical property parameter is obtained based on the color of the flakes.

In particular, in the plastics industry it is common to associate a color with a specific use. For example, red is used for the plastic used to make sparkling drink caps. This application requires a large stress cracking value and a specific melting index range. In another example, white plastic (HDPE) is used for milk bottles. Therefore, when it is possible to associate an estimated value (a range) of melting index to post-consumer plastic divided on the basis of color.

In another example, post-consumer polyolefin-based food grade plastic prior to the shredding step is separated based on the primary application and the physical property parameter is obtained based on the primary application. In other words, when the primary use of post-consumer plastic is known, a range of the melting index value for that plastic can be estimated as it is known that each use requires a certain melting index value. Therefore, the flakes (or the plastic before shredding) are separated into different groups based on the color and/or color and/or type of polymer and a melting index value (or range of values) is associated with each group, for example medium, high and low. Furthermore, a stress cracking value can be associated with any group, for example, the group having the white plastic previously used as a milk bottle can have a melting index range between 0.4-0.85 g/10 minutes and high resistance to stress cracking. Therefore, the sorting of post-consumer polyolefin-based food grade plastic made from used material can be based on the color and/or source of the plastic.

In another example, the melting index value of the plastic can be measured before or after shredding or before or after processing inside the recycler 6 by doing a test according to ISO standard 1133-1.

Furthermore, the flakes, after inspection, are separated in the separation center SP, based on the physical property parameter, into a plurality of subsets, where in each subset the flakes are homogeneous with respect to the physical property parameter. Therefore, the flakes of one subset have the same melting index range, different from that of another subset. Furthermore, in such an example, each subset of the plurality of subsets is processed separately through the polyolefin recycler 6 to obtain a respective plurality of food grade recycled polyolefin subsets.

It can be envisaged to separate and process caps and bottles having the same physical property parameter together.

Additionally, food grade recycled polyolefins can be sent to the final inspection unit 7.

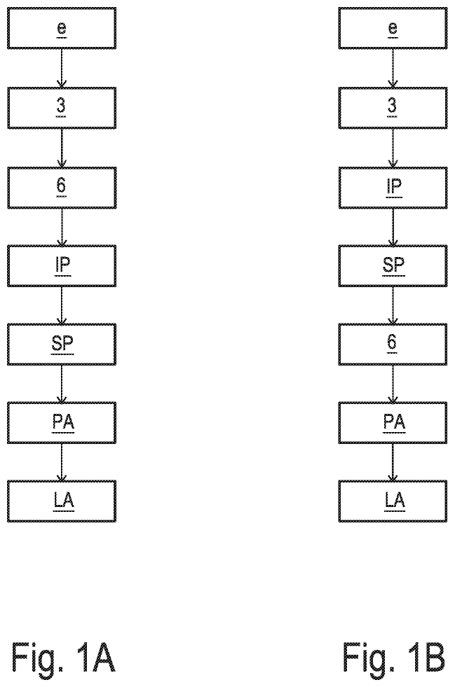

FIGS. 1A and 1B illustrate two distinct embodiments in which the inspection and separation occurs on the granules and flakes respectively. Additionally, the flakes are extruded and pelletized to form food-grade polyolefin granules.

A predetermined quantity of the food grade polyolefin granules is introduced into a pack in a packaging unit PA. The food grade recycled polyolefins of the predetermined quantity of the food grade recycled polyolefins placed in the pack are homogeneous with respect to the physical property parameter. Therefore, each pack contains granules of the same melting index range.

Additionally, in a labeling unit LA, each package is provided with information regarding the physical property parameter of the food-grade recycled polyolefins contained in the pack.

This information can be provided in the form of a label or a QR code on the package.

The information relating to the physical property parameter of food grade recycled polyolefins contained in the packaging may include information on how the physical property parameter is obtained. For example, the information relating to the physical property parameter of recycled polyolefins may specify that the inspection took place based on the color, source of the plastic, through a melting index test, etc., or that the caps and bottles were separated and processed separately. The information relating to the physical property parameter of the recycled polyolefins can specify the exact range or value of the melting index of the granules inside the bag together with an estimate of the resistance to stress cracking. In addition, the physical property parameter information of the food-grade recycled polyolefins contained in the package may include operational information representative of the application of the food-grade recycled polyolefins in a molding process to obtain a final product derived from the food-grade recycled polyolefins of each package depending on the operating conditions of the molding process. For example, such information may specify a suggested percentage of food-grade recycled polyolefins for use in combination with a virgin polymer. Additionally, this information can specify the suggested percentage of a package's food-grade recycled polyolefins to be used in combination with a virgin polymer for a specific process with specific operating conditions.

A pack may have information (recipes) on the suggested percentage of recycled polyolefins within that package to be combined with a virgin polymer in an injection or compression molding process for the production of plastic caps having a specific thickness and for sparkling drinks, based on the melting index range associated with that package. Some examples of such recipes are shown below, for each melting index interval and depending on the thickness desired for the cap and the type of drink, suggested values and optimal values of the granules (of recycled HDPE) are provided having that interval of meeting index. MI indicates melting index.

| Cap | Beverage | | | |
|---|---|---|---|---|
| Thickness | type | MI 0.4-0.85 | MI 1.4-3.3 | MI 3.3-8.5 |
| Sparkling | <0.9 mm | 100-25% | 100-25% | 70-10% |
| | | 30-40% | 30-50% | 5-15% |
| Still | <0.6 mm | 90-10% | 100-10% | 100-10% |
| | | 20-40% | upto 100% | upto 100% |
| Sparkling | >0.9 e <1.7 | 100-25% | 100-25% | 100-25% |
| | | 100-50% | 100-50% | 5-20% |
| Still | >0.6 | 100-10% | 100-10% | 100-10% |
| | | upto 100% | upto 100% | upto 100% |

1. A method for producing polyolefin food grade recyclates, suitable for use in direct contact with food, the method including the following steps:
collecting post-consumer plastic container bales;
dividing the material provided by the post-consumer plastic container bales into a first group, formed of material used for beverage purposes, and a second group, formed of material used for non-beverage purposes;
shredding the first group of material to obtain plastic flakes;
sorting the plastic flakes to derive a first subset, formed of PO flakes and a second subset, formed of PET flakes;
processing the first subset of flakes through a polyolefin recycler, to obtain the polyolefin food grade recyclates.

2. The method according to claim 1, wherein the step of processing the first subset of flakes through the polyolefin recycler includes a step of classifying the first subset of flakes based on polymer type and/or colour.

3. The method according to claim 2, wherein the step of processing the first subset of flakes through the polyolefin recycler further includes the following steps:
extruding the first subset of flakes;
decontaminating and purifying the extruded flakes;
pelletizing the extruded flakes to obtain polyolefin food grade granules.

4. The method according to claim 1, wherein additives are added to the extruded flakes in order to enhance the food grade of the granules obtained, the additives including virgin polyolefins and/or anti-oxidants.

5. The method according to claim 1, wherein the step of processing the first subset of flakes through the polyolefin recycler further includes a deodorization step, wherein the deodorization is performed on the first subset of flakes after the step of extrusion or on the polyolefin food grade granules obtained from the step of pelletizing the flakes.

6. The method according to claim 1, wherein the polymer separation is carried out through NIR systems.

7. The method according to claim 1, further comprising a step of preselecting, applied to the first subset of flakes prior to the step of processing the first subset of flakes in the polyolefin recycler, the step of preselecting including inspection of the first subset to identify undesired items and/or possible contaminations in the first subset of flakes.

8. The method according to claim 7, wherein the step of preselecting is carried out though an artificial intelligence visual control system, and/or olfactory sensors for identifying contaminations.

9. The method according to claim 1, further comprising a step of inspecting the food grade of the polyolefin recyclates, downstream of the processing step to verify that the food grade corresponds to a predetermined grade.

10. The method according to claim 1, comprising the following steps:
collecting plastic caps used in refillable/reusable beverage bottles;
shredding the plastic caps to obtain plastic cap flakes, wherein the plastic cap flakes are classified in the first subset of flakes,
wherein the first subset of flakes processed through the polyolefin recycler also includes the plastic cap flakes.

11. The method according to claim 1, wherein the division of the material into the first group and the second group is applied to the post-consumer plastic container bales collected, so that each post-consumer plastic container bale collected belongs either to the first group or to the second group.

12. The method according to claim 1, wherein the step of processing the first subset of flakes through the polyolefin recycler comprises the following steps:
further grinding the first subset of flakes to obtain homogenized flakes;
demetallizing the first subset of flakes;
washing the first subset of flakes;
classifying first subset of flakes based on polymer type and/or colour;
extruding the first subset of flakes;
decontaminating and purifying the extruded flakes;
adding additives to the extruded flakes in order to enhance the food grade of the granules obtained;
pelletizing the extruded flakes to obtain polyolefin food grade granules.

13. The method according to claim 1, wherein the step of sorting the plastic flakes to derive the first and the second subset of flakes is carried out by flotation separation and based on specific gravity.

14. A post-consumer plastic waste treatment system for producing polyolefin food grade recyclates, suitable for use in direct contact with food, comprising:
an input stage to receive post-consumer plastic container bales;
a division centre for dividing the material provided by the post-consumer plastic container bales into a first group, formed of material used for beverage purposes, and a second group, formed of material used for non-beverage purposes;
a shredder configured to shred the first group of material to obtain plastic flakes;
a sorting unit (4) configured for sorting the plastic flakes to derive a first subset, formed of PO flakes and a second subset, formed of PET flakes;
a polyolefin recycler configured for processing the first subset of flakes to obtain the polyolefin food grade recyclates.

15. The post-consumer plastic waste treatment system according to claim 14, wherein the input stage receives plastic caps used in refillable/reusable beverage bottles and wherein the shredder is further configured to shred the plastic caps to obtain plastic cap flakes, the plastic cap flakes being classified in the first subset of flakes, wherein the first subset of flakes processed through the polyolefin recycler also includes the plastic cap flakes.

16. The post-consumer plastic waste treatment system according to claim 14, further comprising a preselection unit, configured to receive the first subset of flakes upstream of the polyolefin recycler, and to inspect the first subset of flakes to identify undesired items and/or possible contaminations in the first subset of flakes.

17. The post-consumer plastic waste treatment system according to claim 14, comprising a final inspection unit configured to inspect the food grade of the polyolefin recyclates, downstream of the polyolefin recycler to verify that the food grade corresponds to a predetermined grade.

18. The post-consumer plastic waste treatment system according to claim 14, wherein the polyolefin recycler comprises:
a polyolefin shredder configured for further grinding the first subset of flakes to obtain homogenized flakes;
a demetallization unit configured for demetallizing the first subset of flakes;
a washing unit configured for washing the first subset of flakes;
a classification unit configured for classifying the first subset of flakes based on polymer type and/or colour;
an extruder for extruding the first subset of flakes;
a decontamination unit configured for decontaminating and purifying the extruded flakes;
an enhancement unit for adding additives to the extruded flakes in order to enhance food grade of the obtained granules;
a pelletizing unit configured to obtain polyolefin food grade granules from the extruded flakes;
a deodorization unit, for deodorizing the first subset of flakes or the polyolefin granules.

19. The method according to claim 1, further comprising the steps of:
determining a melt index value of the plastic flakes or the polyolefin food grade recyclates by performing a melt flow index test;
estimating a stress cracking resistance of the plastic based on the determined melt index value; and
grouping the polyolefin food grade recyclates into groups having a common melt index range or value and associated stress cracking resistance;
labelling each group with operational information representative of, based on the estimated stress cracking resistance.

20. A method for producing polyolefin food grade recyclates, suitable for use in direct contact with food, the method including the following steps:
collecting post-consumer polyolefin-based food grade plastic formed of material used for beverage purposes
shredding the post-consumer polyolefin-based food grade plastic to obtain flakes;
processing the flakes through a polyolefin recycler, to obtain the polyolefin food grade recyclates;
inspecting the post-consumer polyolefin-based food grade plastic to obtain a physical property parameter thereof;
separating the post-consumer polyolefin-based food grade plastic, based on the physical property parameter into a plurality of groups;
attributing a respective physical property parameter to each group of the plurality of groups;
introducing a predetermined amount of the polyolefin food grade recyclates into a pack, wherein polyolefin food grade recyclates of the predetermined quantity of the polyolefin food grade recyclates placed in the pack are homogeneous with respect to the physical property parameter;
providing each package with information relating to the physical property parameter of the polyolefin food grade recyclates contained in the package.
